(19) United States
(12) Patent Application Publication
(10) Pub. No.: US 2026/0001217 A1
(43) Pub. Date: Jan. 1, 2026

(54) METHODS AND APPARATUS FOR DETERMINING POSE AND SIZE OF OBJECTS USING THREE-DIMENSIONAL MACHINE LEARNING

(71) Applicant: Boston Dynamics, Inc., Waltham, MA (US)

(72) Inventors: Karl Pauwels, Redwood City, CA (US); Michael Kelly, San Francisco, CA (US); Matthew Gardner, Somerville, MA (US)

(21) Appl. No.: 18/758,024

(22) Filed: Jun. 28, 2024

(51) Int. Cl. B25J 9/16; B25J 5/00; B25J 19/02

(52) U.S. Cl. CPC B25J 9/163; B25J 9/1697; B25J 19/023; B25J 5/007

(57) ABSTRACT

Methods and apparatus for controlling a mobile robot to perform an action are provided. The method includes receiving, by at least one computing device associated with a mobile robot, first sensor data and second sensor data, providing as input to at least one machine learning model, the first sensor data, the second sensor data, and camera intrinsics associated with at least one camera configured to sense the first sensor data and/or the second sensor data, wherein the at least one machine learning model is trained to output polyhedron information representing a set of objects in an environment of the mobile robot, and controlling the mobile robot to perform an action based, at least in part, on the polyhedron information output from the at least one machine learning model.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions.

Obtaining an accurate representation of an object to be grasped by a mobile robot may be important to ensure that the mobile robot can plan its movements accordingly to securely grasp the object. For instance, discrepancies between the robot's representation of an object and the actual pose and/or size of the object may result in the robot orienting its end effector in a manner that results in an unsuccessful or unsecure grasp of the object when attempted. Accurately representing and securely grasping objects may enable a mobile robot to perform tasks such as truck unloading and pallet building more efficiently. Some embodiments relate to an end-to-end machine learning approach for detecting the visible extent of objects as oriented three-dimensional (3D) shapes (e.g., polyhedrons). For instance, some embodiments are configured to directly predict the 3D translation, 3D rotation and 3D size of polyhedrons (e.g., cuboids) representing multiple objects in an image at the same time. Such techniques may, in some instances, improve upon existing object detection algorithms that detect a single two-dimensional (2D) plane (e.g., a front face) of an object.

In some embodiments, the invention features a method. The method includes receiving, by at least one computing device associated with a mobile robot, first sensor data and second sensor data, providing as input to at least one machine learning model, the first sensor data, the second sensor data, and camera intrinsics associated with at least one camera configured to sense the first sensor data and/or the second sensor data, wherein the at least one machine learning model is trained to output polyhedron information representing a set of objects in an environment of the mobile robot, and controlling the mobile robot to perform an action based, at least in part, on the polyhedron information output from the at least one machine learning model.

In one aspect, the camera intrinsics include one or more coordinates of the at least one camera and/or a viewing angle of the at least one camera. In another aspect, the camera intrinsics includes first camera intrinsics for a first camera configured to sense the first sensor data and second camera intrinsics for a second camera configured to sense the second sensor data. In another aspect, the first sensor data is image data received from a color camera and the second sensor data is depth data received from a depth sensor. In another aspect, the depth sensor is a time-of-flight sensor.

In another aspect, the first sensor data is first image data received from a first color camera and the second sensor data is second image data received from a second color camera, wherein the first color camera and the second color camera have different fields of view. In another aspect, the first color camera and the second color camera have at least partially overlapping fields of view. In another aspect, the camera intrinsics includes first camera intrinsics for the first color camera and second camera intrinsics for the second color camera. In another aspect, the at least one machine learning model is configured to determine a joint feature map based on the first image data and the second image data, wherein the polyhedron information is based on the joint feature map. In another aspect, the at least one machine learning model is configured to determine a first feature map based on the first image data, determine a second feature map based on the second image data, and perform feature matching based on the first feature map and the second feature map to generate a correlation volume, wherein the polyhedron information is based on the correlation volume.

In another aspect, the polyhedron information includes a pose estimate and size estimate for each polyhedron in a set of polyhedrons. In another aspect, the pose estimate is a six degree of freedom pose estimate. In another aspect, each polyhedron in the set of polyhedrons is a cuboid. In another aspect, the size estimate includes a depth dimension, a width dimension, and a height dimension of the cuboid. In another aspect, the at least one machine learning model is configured to determine a first polyhedron hypothesis and a second polyhedron hypothesis for a polyhedron in a set of polyhedrons, and the polyhedron information includes the first polyhedron hypothesis or the second polyhedron hypothesis.

In another aspect, controlling the mobile robot to perform an action based, at least in part, on the polyhedron information comprises controlling the mobile robot to grasp a first object of the set of objects based, at least in part, on the polyhedron information. In another aspect, controlling the mobile robot to perform an action based, at least in part, on the polyhedron information comprises controlling the mobile robot to orient an end effector of the mobile robot based, at least in part, on the polyhedron information. In another aspect, the set of objects includes a set of boxes, and the at least one machine learning model includes a box detection model. In another aspect, at least one object in the set of objects is represented by at least two polyhedrons in the polyhedron information.

In some embodiments, the invention features a mobile robot. The mobile robot includes a first sensor module configured to sense first sensor data, a second sensor module configured to sense second sensor data, a processor configured to receive the first sensor data from the first sensor module and the second sensor data from the second sensor module, and provide as input to at least one machine learning model, the first sensor data, the second sensor data, and camera intrinsics associated with at least one camera configured to sense the first sensor data and/or the second sensor data, wherein the at least one machine learning model is trained to output polyhedron information representing a set of objects in an environment of the mobile robot, and a controller configured to control the mobile robot to perform an action based, at least in part, on the polyhedron information output from the at least one machine learning model.

In one aspect, the camera intrinsics include one or more coordinates of the at least one camera and/or a viewing angle of the at least one camera. In another aspect, the camera intrinsics includes first camera intrinsics for a first camera configured to sense the first sensor data and second camera intrinsics for a second camera configured to sense the second sensor data. In another aspect, the first sensor data is image data sensed by a color camera and the second sensor data is depth data sensed by a depth sensor. In another aspect, the depth sensor is a time-of-flight sensor.

In another aspect, the first sensor data is first image data sensed by a first color camera and the second sensor data is second image data sensed by from a second color camera, wherein the first color camera and the second color camera have different fields of view. In another aspect, the first color camera and the second color camera have at least partially overlapping fields of view. In another aspect, the camera intrinsics includes first camera intrinsics for the first color camera and second camera intrinsics for the second color camera. In another aspect, the at least one machine learning model is configured to determine a joint feature map based on the first image data and the second image data, wherein the polyhedron information is based on the joint feature map. In another aspect, the at least one machine learning model is configured to determine a first feature map based on the first image data, determine a second feature map based on the second image data, and perform feature matching based on the first feature map and the second feature map to generate a correlation volume, wherein the polyhedron information is based on the correlation volume.

In another aspect, the polyhedron information includes a pose estimate and size estimate for each polyhedron in a set of polyhedrons. In another aspect, the pose estimate is a six degree of freedom pose estimate. In another aspect, each polyhedron in the set of polyhedrons is a cuboid. In another aspect, the size estimate includes a depth dimension, a width dimension, and a height dimension of the cuboid. In another aspect, the at least one machine learning model is configured to determine a first polyhedron hypothesis and a second polyhedron hypothesis for a polyhedron in a set of polyhedrons, and the polyhedron information includes the first polyhedron hypothesis or the second polyhedron hypothesis.

In another aspect, controlling the mobile robot to perform an action based, at least in part, on the polyhedron information comprises controlling the mobile robot to grasp a first object of the set of objects based, at least in part, on the polyhedron information. In another aspect, controlling the mobile robot to perform an action based, at least in part, on the polyhedron information comprises controlling the mobile robot to orient an end effector of the mobile robot based, at least in part, on the polyhedron information. In another aspect, the set of objects includes a set of boxes, and the at least one machine learning model includes a box detection model. In another aspect, at least one object in the set of objects is represented by at least two polyhedrons in the polyhedron information.

In some embodiments, the invention features a non-transitory computer readable medium including a plurality of processor executable instructions stored thereon that, when executed by a processor, perform a method. The method includes providing as input to at least one machine learning model, first sensor data, second sensor data, and camera intrinsics associated with at least one camera configured to sense the first sensor data and/or the second sensor data, wherein the at least one machine learning model is trained to output polyhedron information representing a set of objects in an environment of a mobile robot, and controlling a mobile robot to perform an action based, at least in part, on the polyhedron information output from the at least one machine learning model.

In one aspect, the camera intrinsics include one or more coordinates of the at least one camera and/or a viewing angle of the at least one camera. In another aspect, the camera intrinsics includes first camera intrinsics for a first camera configured to sense the first sensor data and second camera intrinsics for a second camera configured to sense the second sensor data. In another aspect, the first sensor data is image data received from a color camera and the second sensor data is depth data received from a depth sensor. In another aspect, the depth sensor is a time-of-flight sensor.

In another aspect, the first sensor data is first image data received from a first color camera and the second sensor data is second image data received from a second color camera, wherein the first color camera and the second color camera have different fields of view. In another aspect, the first color camera and the second color camera have at least partially overlapping fields of view. In another aspect, the camera intrinsics includes first camera intrinsics for the first color camera and second camera intrinsics for the second color camera. In another aspect, the at least one machine learning model is configured to determine a joint feature map based on the first image data and the second image data, wherein the polyhedron information is based on the joint feature map. In another aspect, the at least one machine learning model is configured to determine a first feature map based on the first image data, determine a second feature map based on the second image data, and perform feature matching based on the first feature map and the second feature map to generate a correlation volume, wherein the polyhedron information is based on the correlation volume.

In another aspect, the polyhedron information includes a pose estimate and size estimate for each polyhedron in a set of polyhedrons. In another aspect, the pose estimate is a six degree of freedom pose estimate. In another aspect, each polyhedron in the set of polyhedrons is a cuboid. In another aspect, the size estimate includes a depth dimension, a width dimension, and a height dimension of the cuboid. In another aspect, the at least one machine learning model is configured to determine a first polyhedron hypothesis and a second polyhedron hypothesis for a polyhedron in a set of polyhedrons, and the polyhedron information includes the first polyhedron hypothesis or the second polyhedron hypothesis.

In another aspect, controlling the mobile robot to perform an action based, at least in part, on the polyhedron information comprises controlling the mobile robot to grasp a first object of the set of objects based, at least in part, on the polyhedron information. In another aspect, controlling the mobile robot to perform an action based, at least in part, on the polyhedron information comprises controlling the mobile robot to orient an end effector of the mobile robot based, at least in part, on the polyhedron information. In another aspect, the set of objects includes a set of boxes, and the at least one machine learning model includes a box detection model. In another aspect, at least one object in the set of objects is represented by at least two polyhedrons in the polyhedron information.

In some embodiments, the invention features a method of facilitating annotation of an image. The method includes processing an image using a 3D machine learning model trained to output a set of polyhedrons associated with a set of objects in the image, wherein the image is a first image of a stereo image pair, displaying, on a user interface of an annotation tool, an indication of the set of polyhedrons as preseeded annotations for the image, receiving user input via the user interface to adjust the preseeded annotations to generate an updated annotation of the image, wherein the user input is restricted based, at least in part, on information associated with a second image in the stereo image pair, storing the updated annotation of the image as training data, and training the 3D machine learning model using the stored training data.

In another aspect, restricting the user input comprises restricting the user input based on epipolar geometry determined based on a characteristic of an object represented in both the first image and the second image of the stereo image pair. In another aspect, the method further includes performing multipath mitigation on the indication of the set of polyhedrons displayed on the user interface of the annotation tool to adjust the preseeded annotations. In another aspect, each polyhedron in the set of polyhedrons is a cuboid. In another aspect, the set of objects includes a set of boxes, and the 3D machine learning model includes a box detection model. In another aspect, at least one object in the set of objects is represented by at least two polyhedrons in the set of polyhedrons.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 illustrates a schematic illustration of components of a robotic device, according to an illustrative embodiment of the invention.

FIG. 4 illustrates a flowchart of a process for detecting and grasping an object with a robotic device, according to an illustrative embodiment of the invention.

FIG. 5 is a flowchart for controlling a mobile robot to interact with one or more objects represented by polyhedrons according to an illustrative embodiment of the invention.

FIG. 6A schematically illustrates a computing architecture for determining a pose and size of an object from monocular image data, according to an illustrative embodiment of the invention.

FIGS. 6B-6D depict examples of images of stacks of boxes in which the boxes have been detected using a three-dimensional machine learning model, according to illustrative embodiments of the invention.

FIG. 7A schematically illustrates a first computing architecture for determining a pose and size of an object from stereo image data, according to an illustrative embodiment of the invention.

FIG. 7B schematically illustrates a second computing architecture for determining a pose and size of an object from stereo image data, according to an illustrative embodiment of the invention.

FIG. 7C schematically illustrates a process for generating a correlation volume based on features extracted from stereo image data, according to an illustrative embodiment of the invention.

FIG. 7D schematically illustrates a process for generating a matched feature volume from a correlation volume, according to an illustrative embodiment of the invention.

FIG. 8A illustrates a mobile robot including multiple camera modules for capturing stereo image data, according to an illustrative embodiment of the invention.

FIG. 8B depicts an image captured by a first camera module of the mobile robot shown in FIG. 8A, according to an illustrative embodiment of the invention.

FIG. 8C depicts an image captured by a second camera module of the mobile robot shown in FIG. 8B, according to an illustrative embodiment of the invention.

FIG. 9 is a flowchart for determining a pose and size of a polyhedron representing an object, according to an illustrative embodiment of the invention.

FIG. 10 is a flowchart of a process for facilitating annotation of polyhedrons in an image, according to an illustrative embodiment of the invention.

FIG. 11 illustrates an example configuration of a robotic device, according to an illustrative embodiment of the invention.

### DETAILED DESCRIPTION

The speed at which a mobile robot can operate to perform a task such as unloading boxes from a truck or building a pallet of boxes is an important consideration when determining whether to use robots to perform such tasks. The mobile robot may include an onboard perception system to capture sensor data, and the sensor data may be used to detect potential objects (e.g., boxes) to be grasped by the robot. The mobile robot may use the information about the potential object(s) to move its end effector near the object(s) prior to grasping. Inaccuracies in the detection of the object(s) to be grasped may result in reduced pick rates, increased human interventions, and/or damage to the robot and/or objects when the mobile robot attempts to interact with those objects. For instance, some box detection techniques that use depth sensor point cloud data to estimate the three-dimensional shapes of objects may include errors due to the multi-path effects associated with the depth sensor data. To this end, some embodiments relate to techniques for using a three-dimensional (3D) machine learning model to process perception data for a mobile robot that associates a set of polyhedrons (e.g., cuboids) with objects in the mobile robot's environment. Such techniques may estimate the pose and size of the objects in the environment with improved accuracy relative to some existing object detection techniques, thereby enabling a more accurate and/or efficient operation of the mobile robot when interacting with the objects. Although the techniques herein are described with respect to detecting and estimating the pose and size of objects (e.g., boxes) to be grasped by a mobile robot, it should be appreciated that one or more of the techniques described herein may also be used to detect and estimate the pose and size of other objects that a mobile robot may encounter in its environment. Examples of such objects include, but are not limited to, pallets, conveyors, or the interior of trucks or containers. Additionally, some embodiments relate to techniques for obtaining 3D ground truth data that may be used, for example, to train and/or evaluate a 3D machine learning model.

Robots configured to operate in a warehouse or industrial environment are typically either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

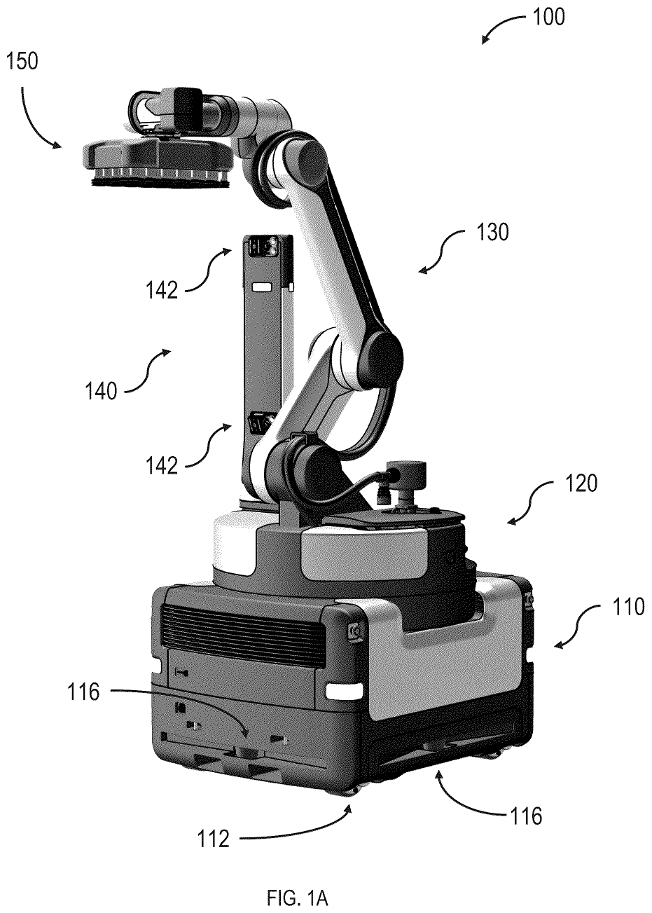

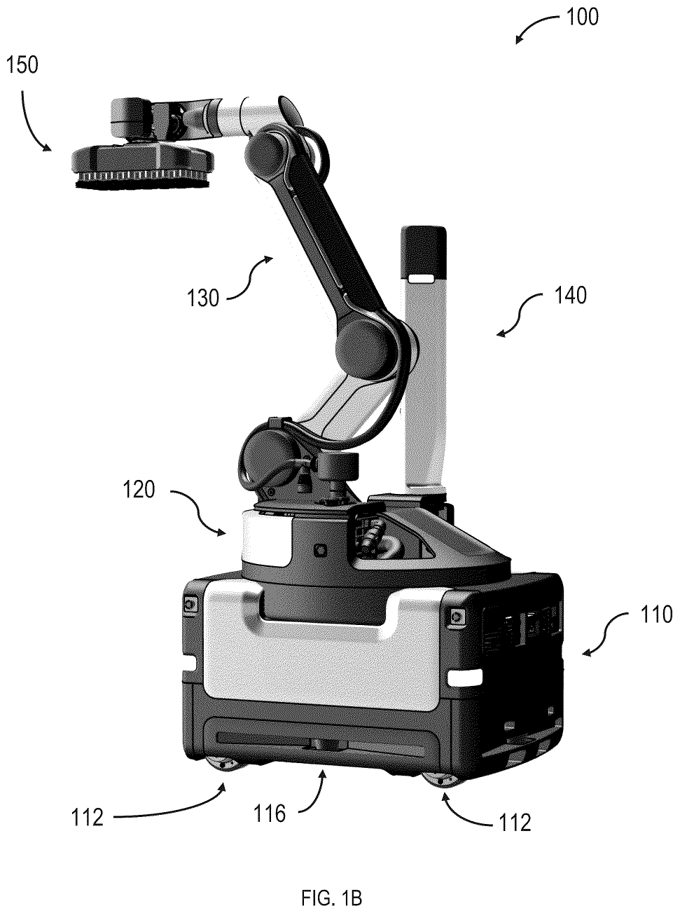

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

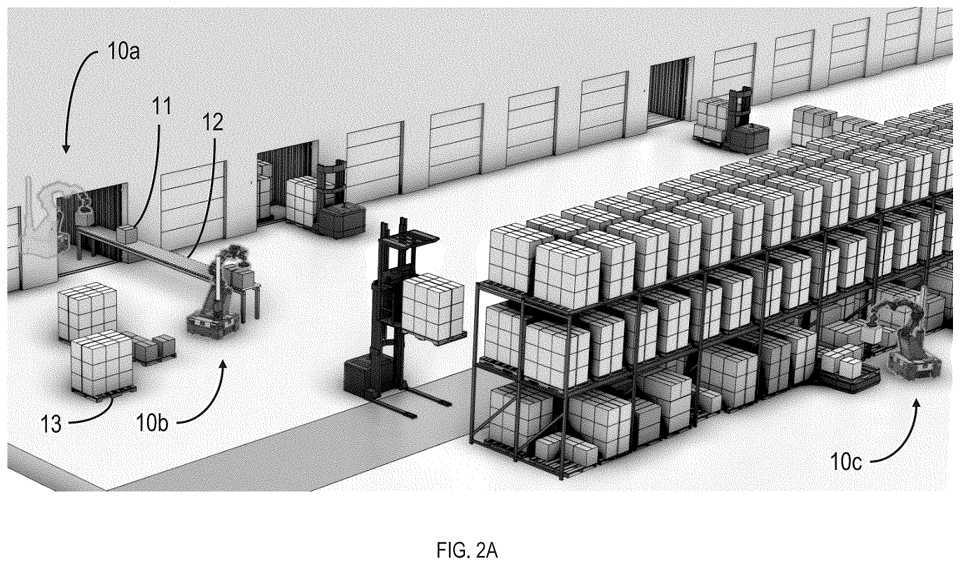

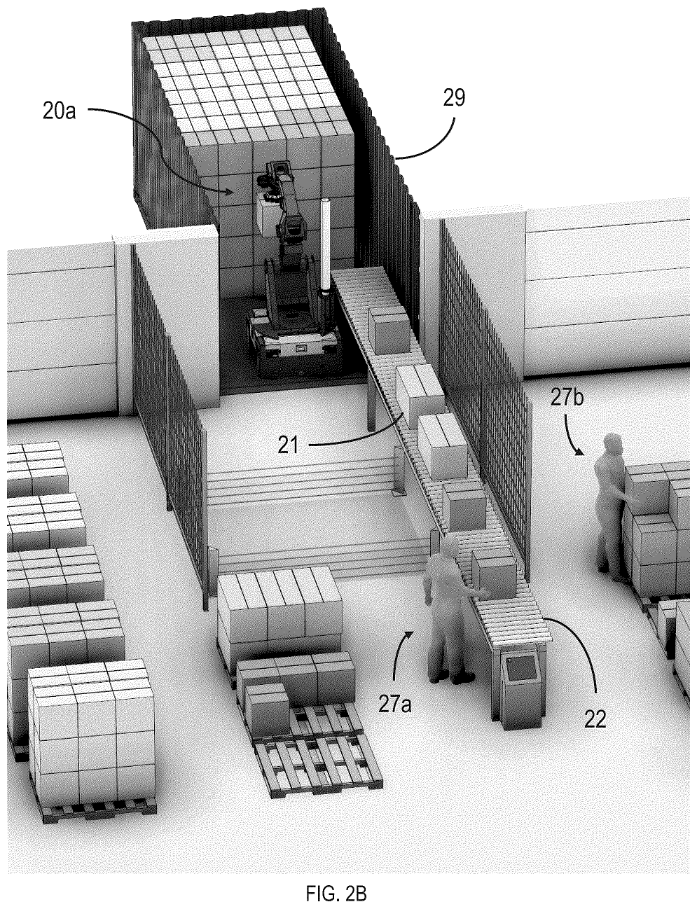

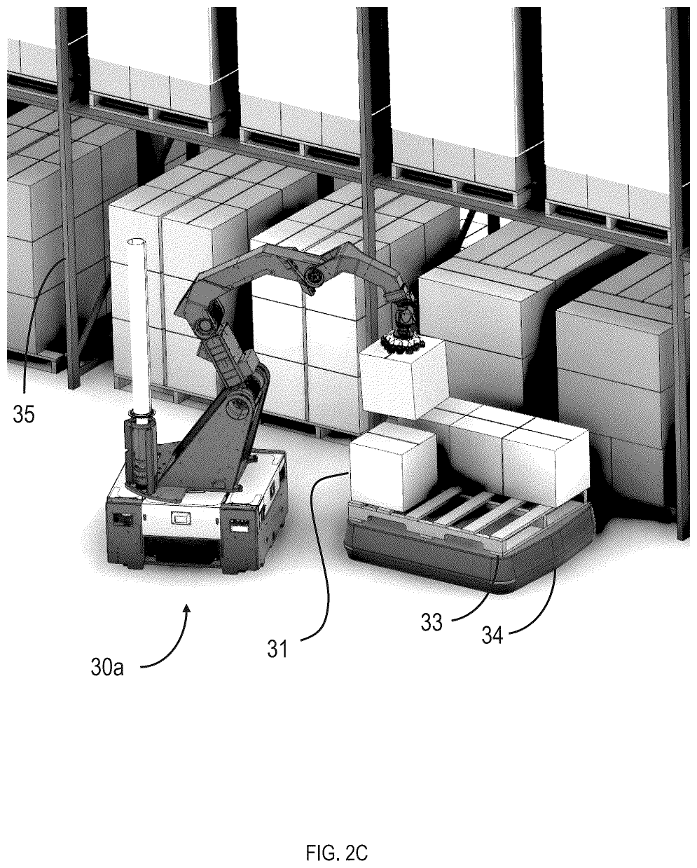

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf, picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

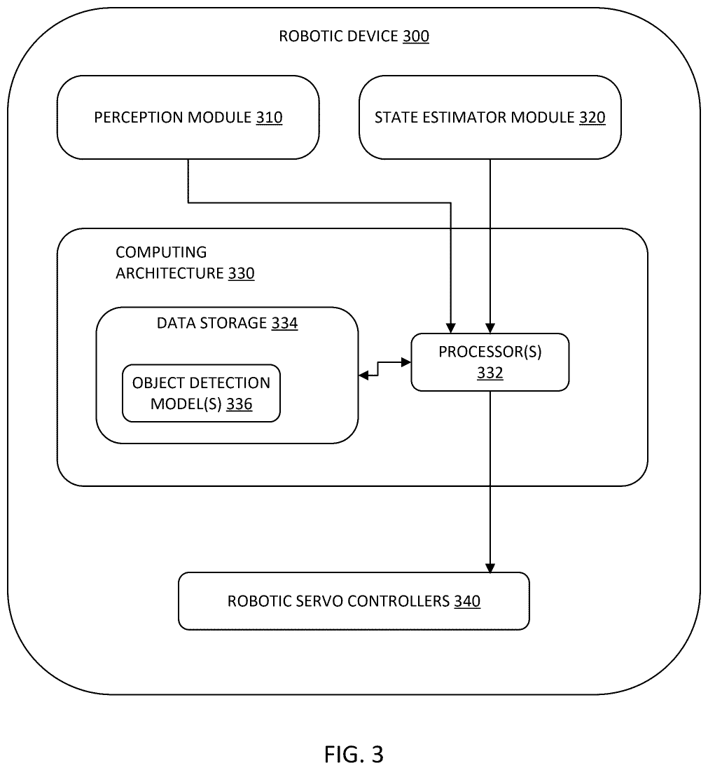

FIG. 3 illustrates an example computing architecture 330 for a robotic device 300, according to an illustrative embodiment of the invention. The computing architecture 330 includes one or more processors 332 and data storage 334 in communication with processor(s) 332. Robotic device 300 may also include a perception module 310 (which may include, e.g., the perception mast 140 shown and described above in FIGS. 1A-1B) and/or a state estimator module 320 configured to determine a state of one or more portions of the robotic device 300. For instance, state estimator module 320 may be configured to provide non-visual input to indicate an object detection issue, as described in more detail below. One or both of these modules may be configured to provide input to processor(s) 332. For instance, perception module 310 may be configured to provide one or more images to processor(s) 332, which may be programmed to detect one or more objects (e.g., boxes) in the provided one or more images. Data storage 334 may be configured to store one or more object detection models 336 (e.g., one or more trained statistical models) used by processor(s) 332 to analyze the one or more images provided by perception module 310 to detect objects in the image(s). Robotic device 300 may also include robotic servo controllers 340, which may be in communication with processor(s) 332 and may receive control commands from processor(s) 332 to move a corresponding portion (e.g., an arm, the base) of the robotic device.

During operation, perception module 310 can perceive one or more objects (e.g., parcels such as boxes) for grasping (e.g., by an end-effector of the robotic device 300) and/or one or more aspects of the robotic device's environment. In some embodiments, perception module 310 includes one or more sensors configured to sense the environment. For example, the one or more sensors may include, but are not limited to, a color camera, a depth camera, a LIDAR or stereo vision device, or another device with suitable sensory capabilities. In some embodiments, image(s) captured by perception module 310 are processed by processor(s) 332 using trained object detection model(s) 336 to extract surfaces (e.g., faces, cuboids) of boxes or other objects in the image capable of being grasped by the robotic device 300.

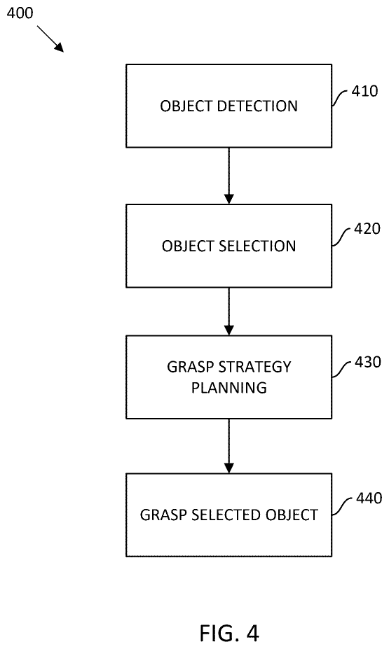

FIG. 4 illustrates a process 400 for grasping an object (e.g., a parcel such as a box, package or other object) using an end-effector of a robotic device in accordance with some embodiments. In act 410, objects (e.g., parcels such as boxes or other objects of interest to be grasped by the robotic device) are detected in one or more images (e.g., RGBD images) captured by a perception module of the robotic device. For instance, the one or more images may be analyzed using one or more trained object detection models to detect one or more object faces, corners, edges, textures, colors, etc. in the image(s). Following object detection, process 400 proceeds to act 420, where a particular object of the set of detected objects is selected (e.g., to be grasped next by the robotic device). In some embodiments, a set of objects capable of being grasped by the robotic device (which may include all or a subset of objects in the environment near the robot) may be determined as object candidates for grasping. Then, one of the object candidates may be selected as the particular object output from act 420, wherein the selection is based on various heuristics, rules, or other factors that may be dependent on the particular environment and/or the capabilities of the particular robotic device. Process 400 then proceeds to act 430, where grasp strategy planning for the robotic device is performed. The grasp planning strategy may, for example, select, from among multiple possible grasp candidates, a manner in which to grasp the object selected as the output of act 420. Grasp strategy planning may include, but is not limited to, the placement of a gripper of the robotic device on or near a surface of the selected object and one or more movements of the robotic device necessary to achieve such gripper placement on or near the selected object. Process 400 then proceeds to act 440, where the object selected in act 420 is grasped by the robotic device according to the grasp strategy planning determined in act 430.

Some existing techniques for detecting objects (e.g., boxes) using the perception system of a mobile robot employ a multi-stage process in which 2D image data (e.g., RGB camera data) and depth sensor data (e.g., time-of-flight sensor data) are used to estimate object characteristics. In a first stage, only the 2D image data may be used to detect the corners of a front face of an object (e.g., using a 2D machine learning model), and in a second stage, only the depth sensor data may be used to estimate the 3D pose and size of the front face using, for example, geometrical computer vision techniques (e.g., fitting a plane to the front face of the object using the corners detected in the first stage). The depth sensor data tends to be particularly sensitive to multipath artifacts caused by reflections in the robot's environment (e.g., the walls inside of a truck or container). To mitigate these multipath distortions, a stereo refinement technique may be implemented to capture a set of stereo images and correct for the multipath distortion. The depth of the object may be determined using various heuristics such as by assuming that objects with the same front face dimensions are likely to have the same depth, that objects such as boxes may not extend beyond the next façade in a stack of boxes, etc.

Although such techniques may work well when the objects to be detected are neatly arranged in a stack near the mobile robot, such techniques may work less well when the objects to be detected are rotated and/or arranged in another manner that is more challenging to identify the front faces of the objects. For example, if a box is rotated 45 degrees relative to the perception module, it may not be clear which face of the box is the front face. As another example, some portions of an object may be occluded by other objects in the imaged scene, which may reduce the accuracy of some existing object detection techniques. As yet another example, thin or damaged objects may be challenging to detect with existing 2D “face detection” techniques. Furthermore, the stereo refinement techniques used to correct for multi-path distortion typically require a highly accurate estimate of the object corners in the stereo pair of images, which may not always be possible to obtain.

Some embodiments of the present disclosure mitigate one or more of the above-described challenges with some existing object detection techniques by providing an end-to-end object detection technique that combines detection and pose/size estimation using a three-dimensional machine learning model trained to output a set of 3D oriented shapes (e.g., polyhedrons) associated with objects (e.g., boxes) in the environment of a mobile robot. In some embodiments, one or more polyhedrons may be represented by a set of vertices (e.g., represented by a corresponding set of spatial coordinates). By configuring the machine learning model to operate directly on the image data provided as input, the techniques described herein may not have an explicit concept of a front face or depth of an object, but instead may directly estimate the visible extent of all object dimensions. By considering the entire scene context and all object properties (e.g., corners, edges, texture, etc.) when determining object pose and size rather than only considering certain types of data at certain stages of processing, pose estimates may be obtained that are more robust compared to existing techniques.

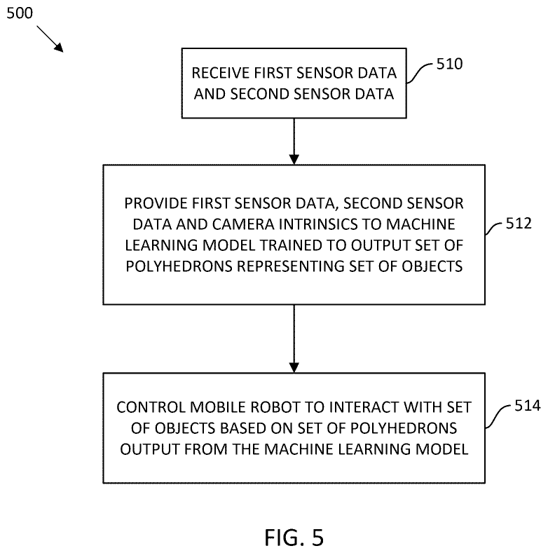

FIG. 5 schematically illustrates a process 500 for controlling a mobile robot to interact with a set of objects associated with polyhedron information output from a 3D machine learning model in accordance with some embodiments. Process 500 begins in act 510, where first sensor data and second sensor data are received from one or more cameras associated with a mobile robot. In some embodiments, the first sensor data and the second sensor data may be associated with the same perception module. For example, each of the perception modules 142 in the robot 100 shown in FIG. 1A may include a 2D camera (e.g., a color camera) and a depth sensor (e.g., a time-of-flight sensor). The first sensor data may correspond to image data captured by a 2D camera and the second sensor data may correspond to depth sensor data captured by the depth sensor. In some embodiments, the first sensor data and the second sensor data may include data received from multiple perception modules. For example, the first sensor data may correspond to first image data captured by a first camera (e.g., a camera included in upper perception module 142 shown in FIG. 1A) and the second sensor data may correspond to second image data captured by a second camera (e.g., a camera included in lower perception module 142 shown in FIG. 1A). In some embodiments, the first camera and second camera may be arranged in a stereo camera configuration with the first camera and the second camera having at least partially overlapping fields of view. In some embodiments, one or more both of the first sensor data and the second sensor data may include 2D image data and depth sensor data.

Process 500 then proceeds to act 512, where the first sensor data, the second sensor data and camera intrinsics are provided as input to a trained machine learning model, where the machine learning model is trained to output a set of polyhedrons representing a set of objects in the environment of the mobile robot. Non-limiting examples of machine learning architectures that may be used in accordance with some embodiments are described in more detail below. When predicting the pose and size of objects that have a cuboidal shape such as boxes or pallets, the predicted polyhedrons output from the trained machine learning model may be cuboids that are an accurate representation of the objects. In the case of arbitrarily shaped objects (e.g., deformed boxes), the predicted cuboids output from the trained machine learning model may represent enclosing cuboids for the object that approximate the actual dimensions of the object. The camera intrinsics may include a location (e.g., one or more coordinates) of at least one camera module, a viewing angle of at least one camera module, etc. to enable the translation from 2D images to a 3D representation of a polyhedron. In some embodiments, the output of the trained machine learning model may be, for each detected object in an image, a polyhedron having a pose (e.g., a 6 degree of freedom pose) and a size. Stated differently, the trained machine learning model may be configured to output a set of polyhedrons (e.g., one or more polyhedrons), with each of the cuboids being associated with a pose and a size. In some embodiments, a particular object in the environment of a mobile robot may be represented by more than one polyhedron. For instance, an extended conveyor in the environment may be represented by two (or more than two) cuboids.

Process 500 then proceeds to act 514, where the mobile robot is controlled to interact with the set of objects represented by the set of polyhedrons output from the trained machine learning model in act 512. The mobile robot may be controlled to interact with the set of objects in any suitable way. For example, as described in connection with process 400 in FIG. 4, the mobile robot may be controlled to perform one or more of selecting one or more of the objects in the set of objects to grasp, performing grasp strategy planning, and/or grasping the selected object from the set of objects.

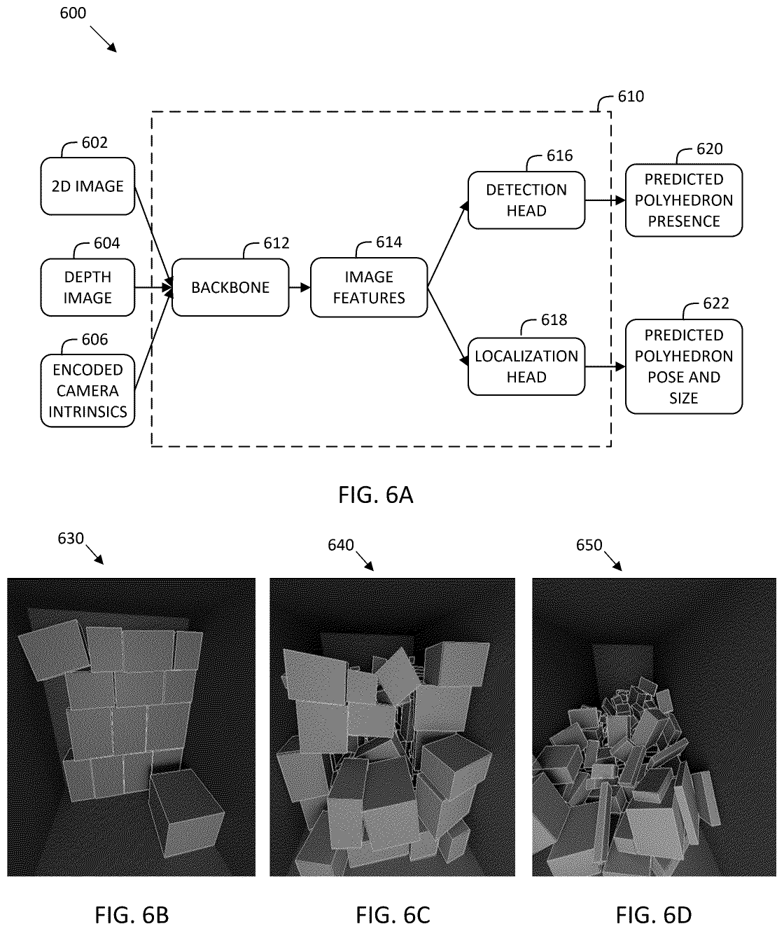

FIG. 6A illustrates an example machine learning architecture 600 for predicting the pose and size of a polyhedron in a set of polyhedrons, in accordance with some embodiments of the present disclosure. Architecture 600 includes a trained machine learning model 610 configured to receive a 2D image 602 (e.g., a color image) a depth image 604 (e.g., a point cloud of depth data), and encoded camera intrinsics 606. In some embodiments, the 2D image 602 may be a 512×512 RGB image, the depth image may be a 512×512 matrix of depth sensor data, and the encoded camera intrinsics may be a 512×512 matrix of camera coordinates (e.g., x, y) and viewing angle. It should be appreciated however, that any suitable size of data structures may be used, and embodiments are not limited in this respect. As shown in FIG. 6A, the 2D image 602, depth image 604 and encoded camera intrinsics are provided as input to backbone 612 of the trained machine learning model 610. In some embodiments, backbone 612 is configured as a convolutional neural network (CNN) having weights trained to extract feature representation 614 from the input data. In some embodiments, backbone 612 is configured using a ResNet neural network architecture. It should be appreciated that backbone 612 may be implemented using feature extraction networks other than ResNet including, but not limited to, Xception, MobileNet, etc.

The feature representation 614 output from backbone 612 may be provided as input to a set of inference networks including detection head 616 and localization head 618. Detection head 616 may be trained to output a prediction 620 indicating the presence/absence of polyhedron(s) in a set of polyhedrons based on the input feature representation 614. Localization head 618 may be trained to output a prediction 622 of the pose (e.g., 6 degree of freedom pose) and size of the polyhedron in the set of polyhedrons when present in the input feature representation 614. In some embodiments, the output of the trained machine learning model 610 may be a set of polyhedrons with the pose and size of each polyhedron in the set of polyhedrons being encoded using distance, rotation and/or size metrics relative to a predicted center point of the polyhedron. For example, each of the eight vertices of a cuboid may be specified relative to a projected 3D center location of the cuboid, the rotation of a cuboid may be encoded using quaternions relative to a canonical cuboid pose, and the size of a cuboid may be encoded as a length or distance metric in three dimensions. It should be appreciated that polyhedrons may be encoded in any suitable way, and the examples provided herein are for illustration only. The inventors have recognized that a cuboid, as an example of a polyhedron, can be represented by 24 equivalent pose+size combinations. In some embodiments, trained machine learning model 610 may be configured to output multiple hypotheses for the predicted pose and size of a polyhedron, and one of the multiple hypotheses may be selected for further use. For instance, the pose and size estimate being the closest to an identity rotation may be selected.

FIGS. 6B-6D show examples of images that have been processed by a three-dimensional object detection model (e.g., machine learning model 610 of architecture 600) to detect cuboids representing boxes, in accordance with some embodiments. The image shown in FIG. 6B includes a stack of boxes in which some of the boxes are rotated at different angles. The 3D trained machine learning model is able to correctly assign cuboids to each of the boxes based on the visible extents of the boxes shown in the input image. The image shown in FIG. 6C shows a stack of boxes of different shapes and sizes with the boxes oriented at different angles. FIG. 6D shows an avalanched pile of boxes having different orientations and characteristics. As shown, despite the somewhat chaotic arrangement of the boxes in FIGS. 6C and 6D, the 3D trained machine learning model is able to assign cuboids to each of the boxes based on the visible extents of the boxes shown in the corresponding input images.

As described above, in some embodiments, each of the first sensor data and the second sensor data may be image data from a different perception module of a mobile robot. As an example, the first sensor data may be first image data captured by an upper perception module arranged on a perception mast of the robot and the second sensor data may be second image data captured by a lower perception module arranged on the perception mast. In such instances, the fields of view of the cameras in the two perception modules may overlap and camera intrinsics and camera extrinsics for the two cameras may be used together with the image information to train a three-dimensional machine learning model to output a set of polyhedrons representing objects in the environment of the mobile robot. For example, a transform between the two cameras can be used to rectify the two images to ensure that correspondences can be found along the same row/column across images. Such rectification effectively reduces the transform to a one dimensional translation (i.e., the stereo baseline), which is provided as input to the three-dimensional machine learning model. Due to the stereo configuration of the two cameras, the depth of objects in the robot's environment may be determined without the use of a depth sensor, which may be advantageous, for example, in certain highly reflective environments such as the inside of a truck or container, where the depth sensor data tends to suffer from multipath artifacts, as described above. The use of stereo image data to estimate object pose and size information also provides other advantages compared with existing object detection techniques including extending the ability of the robot to interact with objects that do not reflect time-of-flight signals (e.g., parcels wrapped in black plastic).

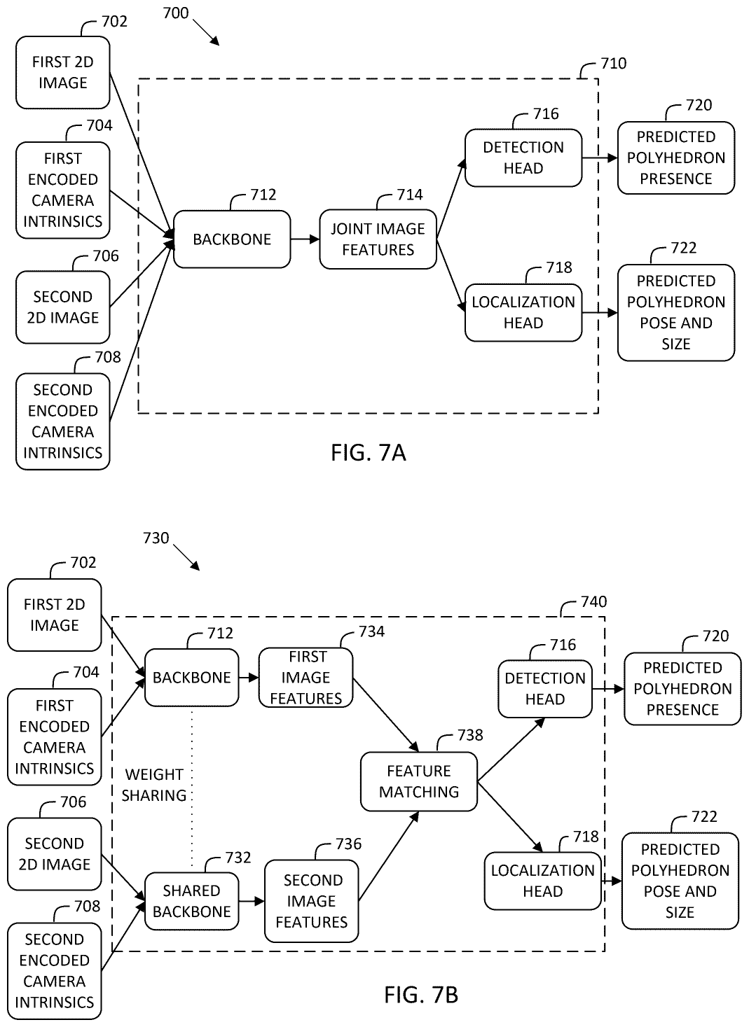

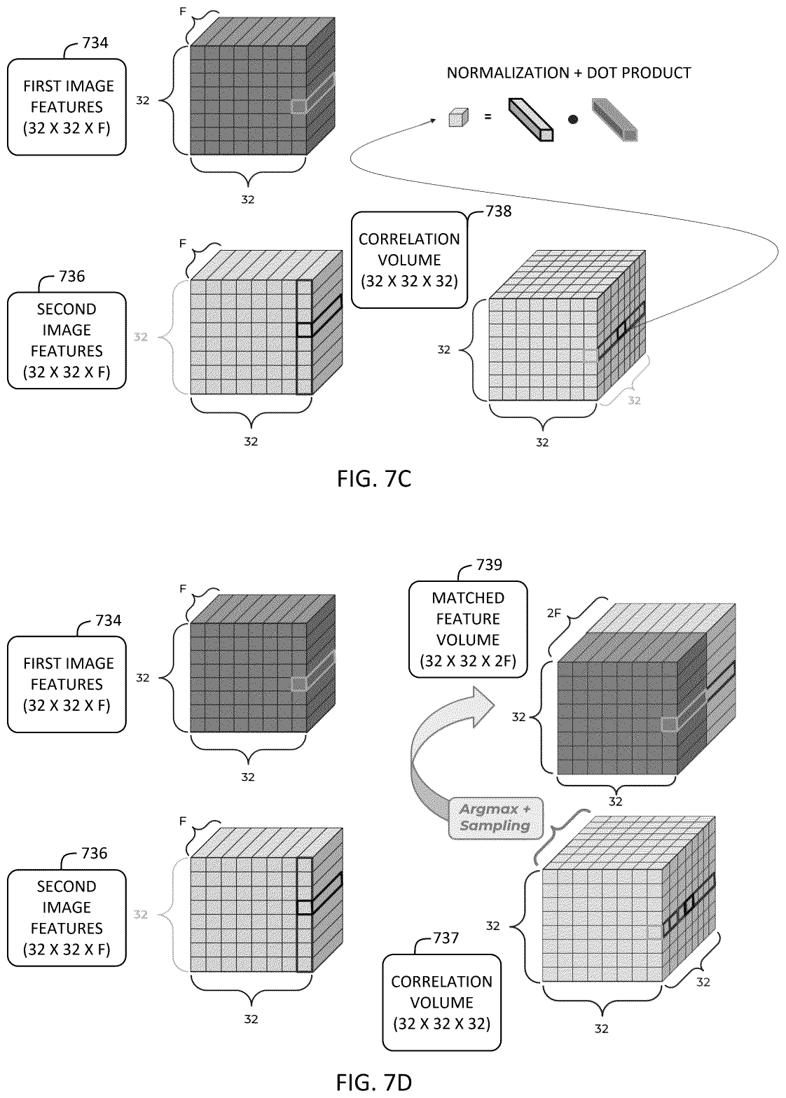

FIG. 7A illustrates a first architecture 700 for processing stereo image data using a trained machine learning model to output a set of polyhedrons, in accordance with some embodiments of the present invention. Architecture 700 includes a trained machine learning model 710 configured to receive a first 2D image 702 (e.g., a first color image), first encoded camera intrinsics 704, a second 2D image 706 (e.g., a second color image), and second encoded camera intrinsics 708. In some embodiments, each of the first 2D image 702 and the second 2D image 706 may be a 512×512 RGB image, and each of the first encoded camera intrinsics 704 and the second encoded camera intrinsics 708 may be a 512×512 matrix of camera coordinates (e.g., x, y) and viewing angle. It should be appreciated however, that any suitable size of data structures may be used, and embodiments are not limited in this respect. As shown in FIG. 7A, the first 2D image 702, the first encoded camera intrinsics 704, the second 2D image 706, and the second encoded camera intrinsics 708 are provided as input to backbone 712 of the trained machine learning model 710. In some embodiments, backbone 712 is configured as a convolutional neural network (CNN) having weights trained to extract a joint feature representation 714 from the input data. In some embodiments, backbone 712 is configured using a ResNet neural network architecture. It should be appreciated that backbone 712 may be implemented using feature extraction networks other than ResNet including, but not limited to, Xception, MobileNet, etc.

The joint feature representation 714 output from backbone 712 may be provided as input to a set of inference networks including detection head 716 and localization head 718. Detection head 716 may be trained to output a prediction 720 indicating the presence/absence of polyhedron(s) in a set of polyhedrons based on the input joint feature representation 714. Localization head 718 may be trained to output a prediction 722 of the pose (e.g., 6 degree of freedom pose) and size of the polyhedrons in the set of polyhedrons when present in the input joint feature representation 714. In some embodiments, the output of the trained machine learning model 710 may be a set of polyhedrons with the pose and size of each polyhedron in the set of polyhedrons being encoded using distance, rotation and/or size metrics relative to predicted center point of the polyhedron. For example, each of the eight vertices of a cuboid may be specified relative to a projected 3D center location of the cuboid, the rotation of the cuboid may be encoded using quaternions relative to a canonical cuboid pose, and the size of the cuboid may be encoded as a length or distance metric in three dimensions. It should be appreciated that polyhedrons may be encoded in any suitable way, and the examples provided herein are for illustration only.

FIG. 7B illustrates a second architecture 730 for processing stereo image data using a trained machine learning model to output a set of polyhedrons, in accordance with some embodiments of the present invention. Architecture 730 includes a trained machine learning model 740 configured to receive a first 2D image 702 (e.g., a first color image), first encoded camera intrinsics 704, a second 2D image 706 (e.g., a second color image), and second encoded camera intrinsics 708. In some embodiments, each of the first 2D image 702 and the second 2D image 706 may be a 512×512 RGB image, and each of the first encoded camera intrinsics 704 and the second encoded camera intrinsics 708 may be a 512×512 matrix of camera coordinates (e.g., x, y) and viewing angle. It should be appreciated however, that any suitable size of data structures may be used, and embodiments are not limited in this respect.

As shown in FIG. 7B, the first 2D image 702 and the first encoded camera intrinsics 704 are provided as input to backbone 712 of the trained machine learning model 740. The second 2D image data 706 and the second encoded camera intrinsics 708 are provided as input to a shared backbone 732 configured to share weights with backbone 712. In some embodiments, each of backbone 712 and shared backbone 732 is configured as a convolutional neural network (CNN) having weights trained to extract a corresponding feature representation from the corresponding input data. For instance, backbone 712 may include network components trained to output a first feature representation 734 based on the first 2D image 702 and the first encoded camera intrinsics 708, and shared backbone 732 may include network components trained to output a second feature representation 736 based on the second 2D image 706 and the second encoded camera intrinsics 708. In some embodiments, each of backbone 712 and shared backbone 732 is configured using a ResNet neural network architecture. It should be appreciated that backbone 712 and shared backbone 732 may be implemented using feature extraction networks other than ResNet including, but not limited to, Xception, MobileNet, etc.

The trained machine learning model 740 may be configured to correlate (e.g., at an object level) features from the first feature representation 734 and the second feature representation 736 to generate a matched feature representation/volume. By determining object-level correspondences rather than computing dense correspondences at the pixel level, the ease of annotation of such correspondences can be improved. FIGS. 7C and 7D schematically illustrate a process for generating a matched feature representation 739 based on a first feature representation (e.g., first feature representation 734) and a second feature representation (e.g., second feature representation 736), in accordance with some embodiments. As shown in FIG. 7C, each of the first feature representation 734 and the second feature representation 736 may have dimensions N×N×F, where an example of N is 32. The correlation volume 737 (having dimensions N×N×N) may be determined by taking the dot product of corresponding elements in the first feature representation 734 and the second feature representation 736 as shown in FIG. 7C. As shown in FIG. 7D, the matched feature representation 739 (having dimensions N×N×2F) may be determined by sampling and applying the argmax function to elements of the correlation volume 737.

The matched feature representation 739 output from the matched feature volume 738 may be provided as input to a set of inference networks including detection head 716 and localization head 718. Detection head 716 may be trained to output a prediction 720 indicating the presence/absence of polyhedron(s) in a set of polyhedrons based on the input joint feature representation 714. Localization head 718 may be trained to output a prediction 722 of the pose (e.g., 6 degree of freedom pose) and size of the polyhedrons in the set of polyhedrons when present in the input joint feature representation 714. In some embodiments, the output of the trained machine learning model 710 may be a set of polyhedrons with the pose and size of each polyhedron in the set of polyhedrons being encoded using distance, rotation and/or size metrics relative to predicted center point of the polyhedron. For example, each of the eight vertices of the cuboid may be specified relative to a projected 3D center location of the cuboid, the rotation of the cuboid may be encoded using quaternions relative to a canonical cuboid pose, and the size of the cuboid may be encoded as a length or distance metric in three dimensions. It should be appreciated that cuboids may be encoded in any suitable way, and the examples provided herein are for illustration only.

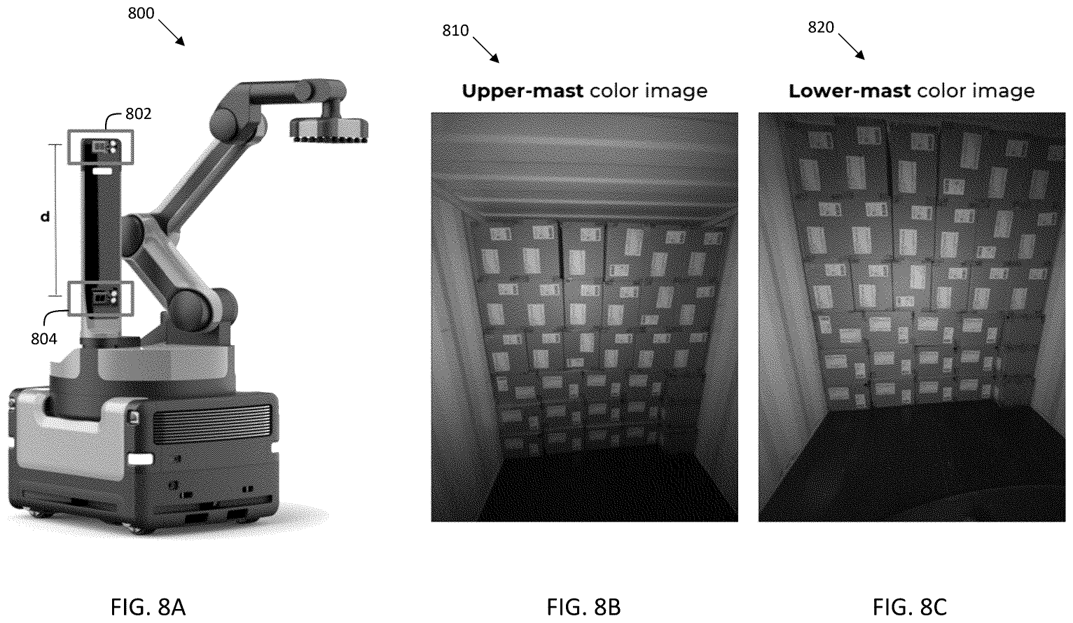

FIG. 8A illustrates an example of a mobile robot 800 including a set of camera modules including an upper camera module 802 and a lower camera module 804 separated by a distance d along a perception mast. FIG. 8B shows that the upper camera module 802 may be configured to capture a first image 810 and FIG. 8C shows that the lower camera module 804 may be configured to capture a second image 820. It should be appreciated that each of the first image 810 and the second image 820 depict the same stack of boxes but from different perspectives. When analyzed together using the one or more of the techniques described herein, polyhedrons (“e.g., cuboids) can be assigned to represent the boxes in the stack shown in the images.

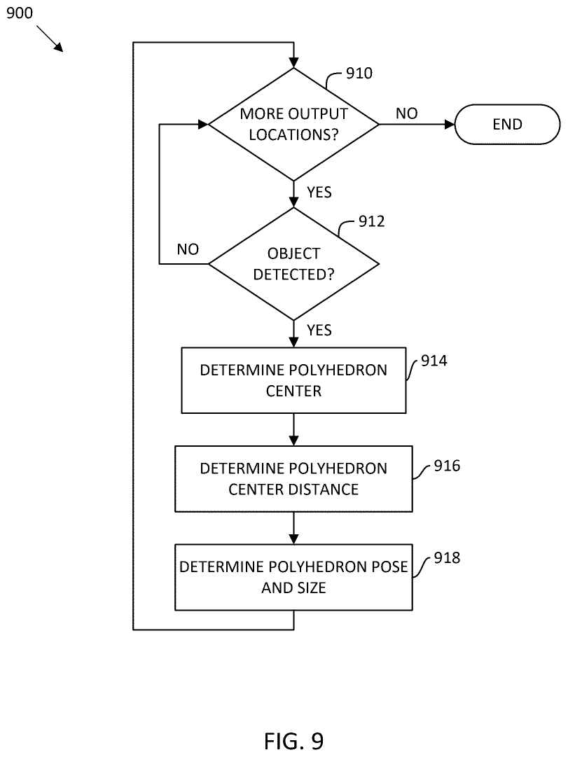

FIG. 9 illustrates a flowchart of a process 900 for determining the pose and size of a polyhedron in accordance with some embodiments of the present disclosure. As described herein, the output of a trained machine learning model (e.g., machine learning model 610, 710, 740, etc.) may be a set of polyhedrons, with each of the polyhedrons in the set having a determined pose (e.g., 6 degree of freedom pose) and size. Process 900 begins in act 910, where it is determined whether there more locations in the output representation of the model that have not yet been evaluated. If it is determined that there are more locations in the output representation of the model to evaluate, process 900 proceeds to act 912, where it is determined (e.g., based on the prediction 920 output from the trained machine learning model 710 in FIG. 7A) whether there is an object at the next location. If it is determined that there is an object at that location, process 900 proceeds to act 914, where the center of the polyhedron is determined (in two dimensions). Process 900 then proceeds to act 916, where the distance from the camera to the center of the polyhedron is determined based, at least in part, on the camera intrinsics associated with the camera. Process 900 then proceeds to act 918, where the pose and size of the polyhedron is determined. For instance, a rotation of a nominal cuboid centered at the predicted center of the cuboid may be determined to provide the cuboid pose information, and the size or dimensions (e.g., width, height, depth) of the cuboid may be determined by scaling the rotated cuboid according to the information captured in the image(s) input to the trained machine learning model, resulting in a scaled and rotated cuboid located at the predicted center position. As described above, in some embodiments, the pose and size estimation for a polyhedron may be performed multiple times to generate multiple pose and size hypotheses to disambiguate polyhedrons oriented using multiple symmetry axes, and one of the hypotheses may be selected for further use. Process 900 may then return to act 910, where it is determined whether further locations in the output representation have yet to be evaluated, and the acts in process 900 may repeat until it is determined in act 910 that all output locations have been evaluated. In some embodiments, all of the locations in the output representation of the model describing the set of polyhedrons may be determined simultaneously as output of the trained machine learning model. In such embodiments, the acts of process 900 shown in FIG. 9 may be performed in parallel rather than being performed serially in a loop as shown in FIG. 9.

In embodiments where the first sensor data and the second sensor data correspond to stereo image data, the depth information for a polyhedron may be determined based, at least in part, on a predicted disparity between the projections of the polyhedron center for each of the two images, stereo calibration information for the two cameras that captured the images and camera intrinsics for the two cameras as described herein. For example, the predicted center point of the cuboid in the first image may be projected to a first location based on camera intrinsics and the stereo baseline, and the predicted center point of the polyhedron in the second image may be projected to a second location based on camera intrinsics and the stereo baseline. The disparity between the first location and the second location may be used to estimate the depth of the polyhedron from the stereo pair of cameras.

The ability of the 3D machine learning model to generalize and perform well may be dependent on the type and amount of training data that is provided to the model during training. In the particular case of the 3D object detection machine learning models described herein, the training data comprises fully annotated images in which most or all visible extents of objects in the image are labeled as being part of a cuboid associated with an object in the image. The inventors have recognized and appreciated that the annotating process itself is laborious and prone to errors when humans annotate captured images of objects from scratch. To this end, some embodiments relate to an annotation tool that provides annotators with initial “preseeded annotations.” By providing annotators with a preseeded starting point to perform an annotation, the annotator may need only make small adjustments to the preseeded annotations to arrive at the full annotation of the image. Additionally, some embodiments use information from stereo pairs of images to restrict the adjustments that an annotator can make to the preseeded annotations during annotation, which may further improve the efficiency and/or consistency of the annotation process.

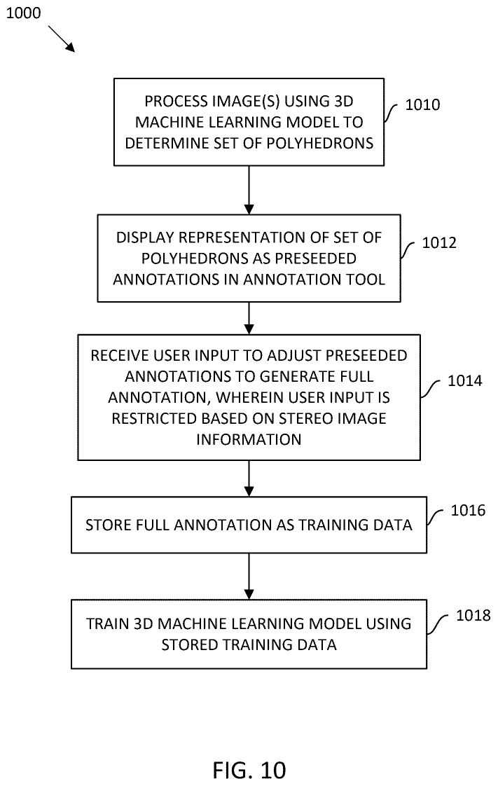

FIG. 10 illustrates a flowchart of a process 1000 for facilitating annotation of images used to train a 3D machine learning model, in accordance with some embodiments of the present disclosure. Process 1000 begins in act 1010, where one or more images are processed using a trained 3D machine learning model to determine a set of polyhedrons (e.g., cuboids) associated with one or more objects in the image. Non-limiting examples of trained 3D machine learning models are described herein. Process 1000 then proceeds to act 1012, where a representation of the polyhedrons in the set of cuboids is displayed as preseeded annotations in a user interface of an annotation tool. For instance, the preseeded annotations corresponding to the cuboids may be displayed as colored outlines associated with each of a plurality of boxes detected in the image. As described above, although the preseeded annotations determined by the 3D machine learning model may not be perfectly aligned with the objects in the image, they may provide a good starting point for a human annotator to specify a full annotation of the image. In some embodiments, the preseeded annotations may be determined based, at least in part, on applying multipath mitigation techniques to the output of the 3D machine learning model. Some examples of multipath mitigation techniques are described herein.

Process 1000 then proceeds to act 1014, where user input is received via the user interface of the annotation tool. In some embodiments, a user may specify a region of interest in the image that includes the preseeded annotations and the 3D machine learning model may be used to predict a 3D oriented polyhedron (e.g., a cuboid) for a single object within the region of interest, which may further refine the preseeded annotations for that polyhedron. In some embodiments, the user input for adjusting the preseeded annotations may be restricted, which may improve the efficiency and consistency of the annotations For instance, rather than allowing a user to modify the preseeded annotations in any manner that they choose, in some embodiments the user input may be restricted to only allow for certain adjustments. For example, based on information in a stereo pair of images, stereo guides (e.g., epipolar lines) may be used to restrict user input to ensure that the corners of the objects (e.g., boxes) are in agreement across the two stereo images. In this way, the user may only be allowed to make adjustments by shifting the preseeded annotations along the epipolar lines. By providing the human annotator with a better starting point and annotation tools that guide the annotation in image space, the process of obtaining high-quality 3D training data that may be used to train/retrain the 3D machine learning model may be improved.

Process 1000 then proceeds to act 1016, where the full annotation of the image determined on the basis of the user input is stored as training data. Process 1000 then proceeds to act 1018, where the 3D machine learning model is trained/retrained using the stored training data. It should be appreciated that the 3D machine learning model may be retrained at any suitable time interval (e.g., daily, weekly, after a certain amount of new training data has been annotated, etc.).

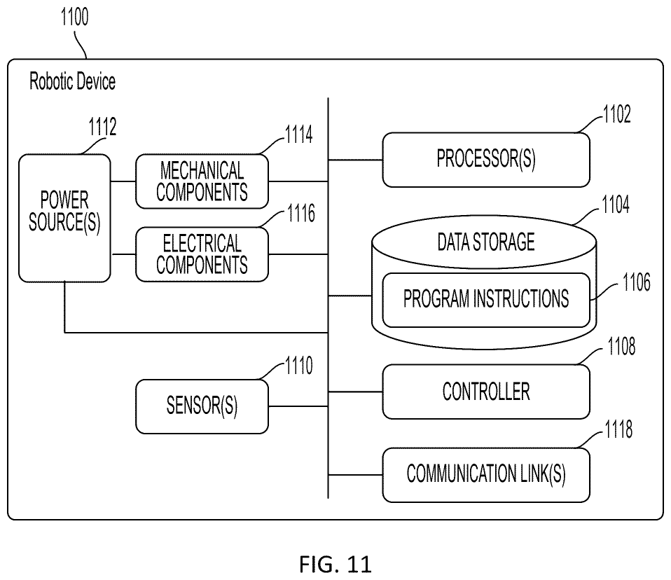

FIG. 11 illustrates an example configuration of a robotic device (or “robot”) 1100, according to an illustrative embodiment of the invention. The robotic device 1100 represents an example robotic device configured to perform the operations described herein. Additionally, the robotic device 1100 may be configured to operate autonomously, semi-autonomously, and/or using directions provided by user(s), and may exist in various forms, such as a humanoid robot, biped, quadruped, or other mobile robot, among other examples. Furthermore, the robotic device 1100 may also be referred to as a robotic system, mobile robot, or robot, among other designations.

As shown in FIG. 11, the robotic device 1100 includes processor(s) 1102, data storage 1104, program instructions 1106, controller 1108, sensor(s) 1110, power source(s) 1112, mechanical components 1114, and electrical components 1116. The robotic device 1100 is shown for illustration purposes and may include more or fewer components without departing from the scope of the disclosure herein. The various components of robotic device 1100 may be connected in any manner, including via electronic communication means, e.g., wired or wireless connections. Further, in some examples, components of the robotic device 1100 may be positioned on multiple distinct physical entities rather on a single physical entity. Other example illustrations of robotic device 1100 may exist as well.

Processor(s) 1102 may operate as one or more general-purpose processor or special purpose processors (e.g., digital signal processors, application specific integrated circuits, etc.). The processor(s) 1102 can be configured to execute computer-readable program instructions 1106 that are stored in the data storage 1104 and are executable to provide the operations of the robotic device 1100 described herein. For instance, the program instructions 1106 may be executable to provide operations of controller 1108, where the controller 1108 may be configured to cause activation and/or deactivation of the mechanical components 1114 and the electrical components 1116. The processor(s) 1102 may operate and enable the robotic device 1100 to perform various functions, including the functions described herein.

The data storage 1104 may exist as various types of storage media, such as a memory. For example, the data storage 1104 may include or take the form of one or more computer-readable storage media that can be read or accessed by processor(s) 1102. The one or more computer-readable storage media can include volatile and/or non-volatile storage components, such as optical, magnetic, organic or other memory or disc storage, which can be integrated in whole or in part with processor(s) 1102. In some implementations, the data storage 1104 can be implemented using a single physical device (e.g., one optical, magnetic, organic or other memory or disc storage unit), while in other implementations, the data storage 1104 can be implemented using two or more physical devices, which may communicate electronically (e.g., via wired or wireless communication). Further, in addition to the computer-readable program instructions 1106, the data storage 1104 may include additional data such as diagnostic data, among other possibilities.

The robotic device 1100 may include at least one controller 1108, which may interface with the robotic device 1100. The controller 1108 may serve as a link between portions of the robotic device 1100, such as a link between mechanical components 1114 and/or electrical components 1116. In some instances, the controller 1108 may serve as an interface between the robotic device 1100 and another computing device. Furthermore, the controller 1108 may serve as an interface between the robotic device 1100 and a user(s). The controller 1108 may include various components for communicating with the robotic device 1100, including one or more joysticks or buttons, among other features. The controller 1108 may perform other operations for the robotic device 1100 as well. Other examples of controllers may exist as well.

Additionally, the robotic device 1100 includes one or more sensor(s) 1110 such as force sensors, proximity sensors, motion sensors, load sensors, position sensors, touch sensors, depth sensors, ultrasonic range sensors, and/or infrared sensors, among other possibilities. The sensor(s) 1110 may provide sensor data to the processor(s) 1102 to allow for appropriate interaction of the robotic device 1100 with the environment as well as monitoring of operation of the systems of the robotic device 1100. The sensor data may be used in evaluation of various factors for activation and deactivation of mechanical components 1114 and electrical components 1116 by controller 1108 and/or a computing system of the robotic device 1100.

The sensor(s) 1110 may provide information indicative of the environment of the robotic device for the controller 1108 and/or computing system to use to determine operations for the robotic device 1100. For example, the sensor(s) 1110 may capture data corresponding to the terrain of the environment or location of nearby objects, which may assist with environment recognition and navigation, etc. In an example configuration, the robotic device 1100 may include a sensor system that may include a camera, RADAR, LIDAR, time-of-flight camera, global positioning system (GPS) transceiver, and/or other sensors for capturing information of the environment of the robotic device 1100. The sensor(s) 1110 may monitor the environment in real-time and detect obstacles, elements of the terrain, weather conditions, temperature, and/or other parameters of the environment for the robotic device 1100.

Further, the robotic device 1100 may include other sensor(s) 1110 configured to receive information indicative of the state of the robotic device 1100, including sensor(s) 1110 that may monitor the state of the various components of the robotic device 1100. The sensor(s) 1110 may measure activity of systems of the robotic device 1100 and receive information based on the operation of the various features of the robotic device 1100, such the operation of extendable legs, arms, or other mechanical and/or electrical features of the robotic device 1100. The sensor data provided by the sensors may enable the computing system of the robotic device 1100 to determine errors in operation as well as monitor overall functioning of components of the robotic device 1100.

For example, the computing system may use sensor data to determine the stability of the robotic device 1100 during operations as well as measurements related to power levels, communication activities, components that require repair, among other information. As an example configuration, the robotic device 1100 may include gyroscope(s), accelerometer(s), and/or other possible sensors to provide sensor data relating to the state of operation of the robotic device. Further, sensor(s) 1110 may also monitor the current state of a function that the robotic device 1100 may currently be operating. Additionally, the sensor(s) 1110 may measure a distance between a given robotic limb of a robotic device and a center of mass of the robotic device. Other example uses for the sensor(s) 1110 may exist as well.

Additionally, the robotic device 1100 may also include one or more power source(s) 1112 configured to supply power to various components of the robotic device 1100. Among possible power systems, the robotic device 1100 may include a hydraulic system, electrical system, batteries, and/or other types of power systems. As an example illustration, the robotic device 1100 may include one or more batteries configured to provide power to components via a wired and/or wireless connection. Within examples, components of the mechanical components 1114 and electrical components 1116 may each connect to a different power source or may be powered by the same power source. Components of the robotic device 1100 may connect to multiple power sources as well.

Within example configurations, any type of power source may be used to power the robotic device 1100, such as a gasoline and/or electric engine. Further, the power source(s) 1112 may charge using various types of charging, such as wired connections to an outside power source, wireless charging, combustion, or other examples. Other configurations may also be possible. Additionally, the robotic device 1100 may include a hydraulic system configured to provide power to the mechanical components 1114 using fluid power. Components of the robotic device 1100 may operate based on hydraulic fluid being transmitted throughout the hydraulic system to various hydraulic motors and hydraulic cylinders, for example. The hydraulic system of the robotic device 1100 may transfer a large amount of power through small tubes, flexible hoses, or other links between components of the robotic device 1100. Other power sources may be included within the robotic device 1100.

Mechanical components 1114 can represent hardware of the robotic device 1100 that may enable the robotic device 1100 to operate and perform physical functions. As a few examples, the robotic device 1100 may include actuator(s), extendable leg(s), arm(s), wheel(s), one or multiple structured bodies for housing the computing system or other components, and/or other mechanical components. The mechanical components 1114 may depend on the design of the robotic device 1100 and may also be based on the functions and/or tasks the robotic device 1100 may be configured to perform. As such, depending on the operation and functions of the robotic device 1100, different mechanical components 1114 may be available for the robotic device 1100 to utilize. In some examples, the robotic device 1100 may be configured to add and/or remove mechanical components 1114, which may involve assistance from a user and/or other robotic device.

The electrical components 1116 may include various components capable of processing, transferring, providing electrical charge or electric signals, for example. Among possible examples, the electrical components 1116 may include electrical wires, circuitry, and/or wireless communication transmitters and receivers to enable operations of the robotic device 1100. The electrical components 1116 may interwork with the mechanical components 1114 to enable the robotic device 1100 to perform various operations. The electrical components 1116 may be configured to provide power from the power source(s) 1112 to the various mechanical components 1114, for example. Further, the robotic device 1100 may include electric motors. Other examples of electrical components 1116 may exist as well.

In some implementations, the robotic device 1100 may also include communication link(s) 1118 configured to send and/or receive information. The communication link(s) 1118 may transmit data indicating the state of the various components of the robotic device 1100. For example, information read in by sensor(s) 1110 may be transmitted via the communication link(s) 1118 to a separate device. Other diagnostic information indicating the integrity or health of the power source(s) 1112, mechanical components 1114, electrical components 1116, processor(s) 1102, data storage 1104, and/or controller 1108 may be transmitted via the communication link(s) 1118 to an external communication device.

In some implementations, the robotic device 1100 may receive information at the communication link(s) 1118 that is processed by the processor(s) 1102. The received information may indicate data that is accessible by the processor(s) 1102 during execution of the program instructions 1106, for example. Further, the received information may change aspects of the controller 1108 that may affect the behavior of the mechanical components 1114 or the electrical components 1116. In some cases, the received information indicates a query requesting a particular piece of information (e.g., the operational state of one or more of the components of the robotic device 1100), and the processor(s) 1102 may subsequently transmit that particular piece of information back out the communication link(s) 1118.

In some cases, the communication link(s) 1118 include a wired connection. The robotic device 1100 may include one or more ports to interface the communication link(s) 1118 to an external device. The communication link(s) 1118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method, comprising:
receiving, by at least one computing device associated with a mobile robot, first sensor data and second sensor data;
providing as input to at least one machine learning model, the first sensor data, the second sensor data, and camera intrinsics associated with at least one camera configured to sense the first sensor data and/or the second sensor data, wherein the at least one machine learning model is trained to output polyhedron information representing a set of objects in an environment of the mobile robot; and
controlling the mobile robot to perform an action based, at least in part, on the polyhedron information output from the at least one machine learning model.

2. The method of claim 1, wherein the camera intrinsics include one or more coordinates of the at least one camera and/or a viewing angle of the at least one camera.

3. The method of claim 1, wherein the camera intrinsics includes first camera intrinsics for a first camera configured to sense the first sensor data and second camera intrinsics for a second camera configured to sense the second sensor data.

4. The method of claim 1, wherein the first sensor data is image data received from a color camera and the second sensor data is depth data received from a depth sensor.

5. The method of claim 4, wherein the depth sensor is a time-of-flight sensor.

6. The method of claim 1, wherein the first sensor data is first image data received from a first color camera and the second sensor data is second image data received from a second color camera, wherein the first color camera and the second color camera have different fields of view.

7. The method of claim 6, wherein the first color camera and the second color camera have at least partially overlapping fields of view.

8. The method of claim 6, wherein the camera intrinsics includes first camera intrinsics for the first color camera and second camera intrinsics for the second color camera.

9. The method of claim 6, wherein the at least one machine learning model is configured to determine a joint feature map based on the first image data and the second image data, wherein the polyhedron information is based on the joint feature map.

10. The method of claim 6, wherein the at least one machine learning model is configured to:
determine a first feature map based on the first image data;
determine a second feature map based on the second image data; and
perform feature matching based on the first feature map and the second feature map to generate a correlation volume, wherein the polyhedron information is based on the correlation volume.

11. The method of claim 1, wherein the polyhedron information includes a pose estimate and size estimate for each polyhedron in a set of polyhedrons.

12. The method of claim 11, wherein the pose estimate is a six degree of freedom pose estimate.

13. The method of claim 11, wherein each polyhedron in the set of polyhedrons is a cuboid.

14. The method of claim 13, wherein the size estimate includes a depth dimension, a width dimension, and a height dimension of the cuboid.

15. The method of claim 1, wherein
the at least one machine learning model is configured to determine a first polyhedron hypothesis and a second polyhedron hypothesis for a polyhedron in a set of polyhedrons, and
the polyhedron information includes the first polyhedron hypothesis or the second polyhedron hypothesis.

16. The method of claim 1, wherein controlling the mobile robot to perform an action based, at least in part, on the polyhedron information comprises:
controlling the mobile robot to grasp a first object of the set of objects based, at least in part, on the polyhedron information; and/or
controlling the mobile robot to orient an end effector of the mobile robot based, at least in part, on the polyhedron information.

17. The method of claim 1, wherein
the set of objects includes a set of boxes, and
the at least one machine learning model includes a box detection model.

18. The method of claim 1, wherein at least one object in the set of objects is represented by at least two polyhedrons in the polyhedron information.

19. A mobile robot, comprising:
a first sensor module configured to sense first sensor data;
a second sensor module configured to sense second sensor data;
a processor configured to:
receive the first sensor data from the first sensor module and the second sensor data from the second sensor module; and
provide as input to at least one machine learning model, the first sensor data, the second sensor data, and camera intrinsics associated with at least one camera configured to sense the first sensor data and/or the second sensor data, wherein the at least one machine learning model is trained to output polyhedron information representing a set of objects in an environment of the mobile robot; and
a controller configured to control the mobile robot to perform an action based, at least in part, on the polyhedron information output from the at least one machine learning model.

20. A non-transitory computer readable medium including a plurality of processor executable instructions stored thereon that, when executed by a processor, perform a method of:
providing as input to at least one machine learning model, first sensor data, second sensor data, and camera intrinsics associated with at least one camera configured to sense the first sensor data and/or the second sensor data, wherein the at least one machine learning model is trained to output polyhedron information representing a set of objects in an environment of a mobile robot; and
controlling a mobile robot to perform an action based, at least in part, on the polyhedron information output from the at least one machine learning model.
